(19) United States
(12) Patent Application Publication
(10) Pub. No.: US 2026/0369806 A1
(43) Pub. Date: Nov. 19, 2026

(54) SOLID-STATE ELECTROLYTE MEMBRANE AND SOLID-STATE LITHIUM BATTERY INCLUDING THE SAME

(71) Applicant: Ming Chi University of Technology, New Taipei City (TW)

(72) Inventors: Chun-Chen YANG, New Taipei City (TW); Yi-Shiuan WU, New Taipei City (TW); Walle Kumlachew ZELALEM, New Taipei City (TW)

(21) Appl. No.: 19/648,226

(22) Filed: Apr. 15, 2026

(30) Foreign Application Priority Data
May 19, 2025 (TW) 114118704

(51) Int. Cl. H01M 50/426; H01M 4/02; H01M 4/58; H01M 10/056; H01M 50/42; H01M 50/434; H01M 50/46

(52) U.S. Cl. CPC H01M 50/426; H01M 4/5825; H01M 10/056; H01M 50/42; H01M 50/434; H01M 50/46; H01M 2004/028; H01M 2300/008

(57) ABSTRACT

A solid-state electrolyte membrane includes a membrane body and a lithium salt electrolyte. The membrane body includes lithium tantalum phosphate, poly(vinylidene fluoride-co-hexafluoropropylene), a lithium salt, and a plasticizer. The lithium salt electrolyte is distributed on the membrane body, and contains lithium difluoro(oxalato)borate, lithium difluorophosphate, and a composite solvent which contains ethylene carbonate and dimethyl carbonate. In the lithium salt electrolyte, a molar concentration of the lithium difluoro(oxalato)borate is 1 M, a weight percentage concentration of the lithium difluorophosphate is 1 wt %, and a volume ratio of the ethylene carbonate to the dimethyl carbonate is 1:1. A solid-state lithium battery including the solid-state electrolyte membrane is also provided.

### CROSS-REFERENCE TO RELATED APPLICATION

This application claims priority to Taiwanese Invention Patent Application No. 114118704, filed on May 19, 2025, the entire disclosure of which is incorporated by reference herein.

### FIELD

The disclosure relates to a solid-state electrolyte membrane and a solid-state lithium battery including the same.

### BACKGROUND

A solid-state battery is a type of secondary battery that utilizes solid-state electrodes and a solid-state electrolyte membrane. Materials for conventional solid-state electrolytes include, for example, lithium aluminum titanium phosphate (LATP), lithium aluminum germanium phosphate (LAGP), lithium lanthanum zirconium oxide (LLZO), lithium lanthanum zirconium tantalum oxide (LLZTO), lithium lanthanum titanium oxide (LLTO), lithium phosphorus oxynitride (LiPON), and lithium tantalum phosphate (LTPO). Compared with some secondary batteries that use liquid electrolytes, solid-state batteries employing solid-state electrolytes can address certain issues associated with liquid electrolytes. However, a solid-state battery still has drawbacks that adversely affect performance, including insufficient contact between the solid-state electrolyte and the solid-state electrodes due to the nature of solid-to-solid contact and high interfacial impedance between them.

For example, CN 117497834 A discloses a technique for addressing insufficient contact between a solid-state electrolyte and solid-state electrodes, and provides a solid-state lithium battery comprising a cathode material, an anode material, an electrolyte membrane, a solid-state electrolyte, and an intermediate layer that is deformable and disposed between the cathode material and the solid-state electrolyte. The solid-state electrolyte includes an LLZTO electrolyte or an LTPO electrolyte. The intermediate layer is a polymer flame-retardant gel, which includes a high-concentration lithium-salt gel or a low-concentration lithium-salt flame-retardant gel. The technique disclosed in CN 117497834 A is capable of improving interfacial contact between the solid-state electrolyte and the cathode material by providing the polymer flame-retardant gel, and further utilizes an aqueous solution treatment method conducted at an interface between the anode material and the solid-state electrolyte to reduce interfacial impedance between the lithium anode and the solid-state electrolyte.

However, CN 117497834 A fails to fully resolve the issue of high interfacial impedance between the solid-state electrolyte and the solid-state electrodes. In particular, research has found that a solid-state electrolyte composed solely of LTPO exhibits very high inherent impedance, leading to low lithium-ion conductivity. Furthermore, as the electrochemical reaction progresses, the significant interfacial impedance between the solid-state electrolyte and the lithium metal foil, which serves as one of the solid-state electrodes, may increase.

### SUMMARY

Therefore, in a first aspect, the present disclosure provides a solid-state electrolyte membrane, which can alleviate at least one of the drawbacks of the prior art. The solid-state electrolyte membrane includes:
a membrane body including lithium tantalum phosphate, poly(vinylidene fluoride-co-hexafluoropropylene), a lithium salt, and a plasticizer; and
a lithium salt electrolyte which is distributed on the membrane body, and which contains lithium difluoro(oxalato)borate, lithium difluorophosphate, and a composite solvent which contains ethylene carbonate and dimethyl carbonate.

In the lithium salt electrolyte, a molar concentration of the lithium difluoro(oxalato)borate is 1 M, a weight percentage concentration of the lithium difluorophosphate is 1 wt %, and a volume ratio of the ethylene carbonate to the dimethyl carbonate is 1:1.

In a second aspect, the present disclosure provides a solid-state lithium battery, which can alleviate at least one of the drawbacks of the prior art. The solid-state lithium battery includes:
a positive electrode (cathode);
a negative electrode (anode) spaced apart from the positive electrode; and
an electrolyte including the aforesaid solid-state electrolyte membrane.

The solid-state electrolyte membrane is disposed between the positive and negative electrodes. A portion of the lithium salt electrolyte is distributed between the positive electrode and the solid-state electrolyte membrane.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a first embodiment of a solid-state electrolyte membrane, which includes a membrane body including lithium tantalum phosphate, poly(vinylidene fluoride-co-hexafluoropropylene), lithium salt, and a plasticizer.

In some embodiments, the lithium tantalum phosphate may be represented by the formula LiTa₂PO₈. In some embodiments, the lithium tantalum phosphate has a median particle size (d₅₀) of 300-450 nm. In some embodiments, the lithium tantalum phosphate is present in an amount ranging from 10 to 150 parts by weight, based on a total poly(vinylidene fluoride-co-hexafluoropropylene) content of 100 parts by weight.

A method for preparing the lithium tantalum phosphate includes, for example, but not limited to, subjecting a precursor powder including a lithium source, a tantalum source, and a phosphorus source to a solid-phase synthesis. Specifically, the precursor powder is initially subjected to ball milling to obtain a processed precursor powder, which is then mixed with isopropanol to form a mixture, followed by calcination to produce a powder form of lithium tantalum phosphate.

The lithium source may be selected from the group consisting of anhydrous lithium hydroxide, lithium nitride, lithium acetate, lithium chloride, lithium hydrogen phosphate, lithium carbonate, and combinations thereof. The tantalum source may be selected from the group consisting of tantalum oxide, tantalum ethoxide, tantalum chloride, and combinations thereof. The phosphorus source may be selected from the group consisting of diammonium hydrogen phosphate, ammonium phosphate, phosphorus pentoxide, phosphoric acid, and combinations thereof. In some embodiments, the lithium source is anhydrous lithium hydroxide, the tantalum source is tantalum oxide, and the phosphorous source is diammonium hydrogen phosphate, in which a molar ratio of the lithium source, the tantalum source, and the phosphorous source is 1:2:1.

Since lithium loss occurs during calcination, an additional amount of lithium source may be added. In some embodiments, the additional amount of the lithium source may range from 5 mol % to 15 mol %, based on a total molar amount of the lithium source, the tantalum source, and the phosphorous source as 100 mol %.

The conditions, parameters, and procedures for the ball milling are within the expertise and routine skills of those skilled in the art. Examples of grinding balls used in the ball milling may include, but are not limited to, zirconia balls, quenched steel balls, stainless steel balls, tungsten carbide balls, silicon nitride balls, yttrium-stabilized zirconia balls, and alumina balls. In certain embodiments, a weight ratio of the precursor powder to the grinding balls may range from 1:1 to 1:20; however, the disclosure is not limited thereto. In certain embodiments, the ball milling rotation speed may range from 50 rpm to 100 rpm; however, the disclosure is not limited thereto. In certain embodiments, a time period for conducting the ball milling may range from 5 hours to 15 hours; however, the disclosure is not limited thereto.

In some embodiments, the poly(vinylidene fluoride-co-hexafluoropropylene) may have a weight-average molecular weight of 400,000.

In some embodiments, the lithium salt may be selected from the group consisting of lithium bis(trifluoromethanesulfonyl)imide (LiTFSI), lithium perchlorate (LiClO₄), lithium trifluoromethanesulfonate (CF₃SO₃Li), lithium bis(oxalato) borate (LiB(C₂O₄)₂), lithium tetrafluoroborate (LiBF₄), and combinations thereof. In an exemplary embodiment, the lithium salt is lithium bis(trifluoromethanesulfonyl)imide.

In some embodiments, a weight ratio of the poly(vinylidene fluoride-co-hexafluoropropylene) to the lithium salt may range from 1:1 to 3:1.

In some embodiments, the plasticizer may be selected from the group consisting of succinonitrile, adiponitrile, lithium azide, polyethylene glycol, poly(ethylene glycol) diacrylate, triallyl isocyanurate, and combinations thereof. In an exemplary embodiment, the plasticizer is succinonitrile.

In some embodiments, the plasticizer may be present in an amount of 20 parts by weight based on 100 parts by weight of the poly(vinylidene fluoride-co-hexafluoropropylene).

An example of a method for preparing the membrane body may include, but is not limited to, the following steps. First, poly(vinylidene fluoride-co-hexafluoropropylene) is mixed with a plasticizer and a first solvent to obtain a polymer solution, and then the lithium salt is added to the polymer solution to obtain a lithium salt-polymer composite solution. Next, the lithium salt-polymer composite solution is mixed with a lithium tantalum phosphate (LTPO) dispersion that includes lithium tantalum phosphate and a second solvent, thereby obtaining a slurry. Subsequently, the slurry is coated onto a substrate to form a thin film, which is then dried to obtain the membrane body. The first solvent and the second solvent may be identical, for example, but not limited to, both being N, N-dimethylformamide.

In a second embodiment of the present disclosure, the solid-state electrolyte membrane, in addition to the aforesaid membrane body, further includes a lithium salt electrolyte. The lithium salt electrolyte is distributed within the membrane body and contains lithium difluoro(oxalato)borate, lithium difluorophosphate, and a composite solvent comprising ethylene carbonate and dimethyl carbonate. In certain embodiments, in the lithium salt electrolyte, the lithium difluoro(oxalato)borate is present at a molar concentration of 1 M, and the lithium difluorophosphate is present at a weight percentage of 1 wt %. In certain embodiments, in the lithium salt electrolyte, a volume ratio of the ethylene carbonate to the dimethyl carbonate is 1:1.

The present disclosure also provides a first embodiment of a solid-state lithium battery, which includes a positive electrode (cathode), a negative electrode (anode) spaced apart from the positive electrode, and an electrolyte. In some embodiments, the positive and negative electrodes may be identical, each a lithium metal foil.

In some embodiments, the positive electrode may be different from the negative electrode. Specifically, the negative electrode is a lithium metal foil, and the positive electrode includes a current collector and an active layer disposed on a surface of the current collector. The active layer may include lithium iron phosphate and lithium tantalum phosphate. An example of the current collector may be, but is not limited to, a carbon-coated aluminum foil. The active layer is formed from a paste containing lithium iron phosphate, a conductive carbon black (i.e., Super P® Li, Imerys Graphite & Carbon Switzerland SA), vapor-grown carbon fibers, a lithium salt, lithium tantalum phosphate, and polyvinylidene fluoride. Examples of the lithium salt in the paste may include, but are not limited to, lithium bis(trifluoromethanesulfonyl)imide (LiTFSI), lithium perchlorate (LiClO₄), lithium trifluoromethanesulfonate (CF₃SO₃Li), lithium bis(oxalato) borate (LiB(C₂O₄)₂), lithium tetrafluoroborate (LiBF₄), and combinations thereof. In an exemplary embodiment, a weight ratio of the lithium iron phosphate, the conductive carbon black, the vapor-grown carbon fibers, the lithium salt, the lithium tantalum phosphate, and the polyvinylidene fluoride is 75:9:1:4:3:8.

According to the present disclosure, the electrolyte includes the first or second embodiment of the solid-state electrolyte membrane mentioned above, which is disposed between the positive and negative electrodes. When the electrolyte includes the second embodiment of the solid-state electrolyte membrane, where the lithium salt electrolyte is contained therein, a portion of the lithium salt electrolyte is distributed between the positive electrode and the solid-state electrolyte membrane. In some embodiments, the lithium salt electrolyte may be present in an amount of 0.4 parts by weight based on 100 parts by weight of the positive electrode, the negative electrode, and the solid-state electrolyte membrane.

Apart from being distributed between the positive electrode and the solid-state electrolyte membrane, another portion of the lithium salt electrolyte may also be distributed between the negative electrode and the solid-state electrolyte membrane due to the fluidity and diffusivity thereof.

The lithium salt electrolyte can enhance wettability at the interface between the positive electrode and the solid-state electrolyte membrane, thereby improving contact therebetween and enabling the solid-state lithium battery to be charged and discharged at high charge/discharge rates (e.g., 1 C, 2 C, 3 C, etc.). The lithium salt electrolyte can further reduce the interfacial impedance between the positive electrode and the solid-state electrolyte membrane, thereby improving the performance of the solid-state lithium battery. During charging and discharging of the solid-state lithium battery, the lithium salt electrolyte enables the formation of a stable cathode electrolyte interphase (CEI) between the positive electrode and the solid-state electrolyte membrane. Moreover, when the lithium salt electrolyte is also distributed between the negative electrode and the solid-state electrolyte membrane, a stable and dense solid-state electrolyte interphase (SEI) can be formed between the negative electrode and the solid-state electrolyte membrane. The stable and dense SEI not only prevents direct contact between the lithium tantalum phosphate in the membrane body of the solid-state electrolyte membrane and the negative electrode (e.g., a lithium metal foil), thereby reducing the possibility of Ta⁵⁺ being reduced to Ta³⁺, Ta²⁺, or zero-valent Ta (i.e., elemental Ta), but also inhibits the growth of lithium dendrites, thereby enhancing the charge-discharge cycling stability and discharge capacity retention rate of the solid-state lithium battery.

The present disclosure will be further described by way of the following examples. However, it should be understood that the following examples are intended solely for the purpose of illustration and should not be construed as limiting the present disclosure in practice.

### EXAMPLES

### <Preparation Example 1> Lithium Tantalum Phosphate Powder

First, based on a Li:Ta:P molar ratio of 1:2:1, anhydrous lithium hydroxide (LiOH), tantalum pentoxide (Ta₂O₅), and diammonium hydrogen phosphate ((NH₄)₂HPO₄) were weighed. To compensate for the loss of the anhydrous LiOH during calcination conducted subsequently, an additional 10 mol % of anhydrous LiOH was weighed. The aforesaid weighted anhydrous LiOH, tantalum pentoxide, and diammonium hydrogen phosphate were then mixed to form a precursor powder.

Subsequently, the precursor powder and multiple zirconia balls at a weight ratio of 1:10 were loaded into a ball-milling jar and subjected to ball milling at a rotation speed of 100 rpm for 3 hours. During the ball milling, the precursor powder was milled with the zirconia balls, thereby obtaining a processed precursor powder. Thereafter, the processed precursor powder was mixed with an appropriate amount of isopropanol in a three-dimensional (3D) shaker mixer (Willy A. Bachofen AG; Model: TURBULA®) for 6 hours to obtain a mixture. Next, the mixture was initially dried at 80 °C for 12 hours, and then subjected to first calcination at 650 °C for 8 hours, followed by second calcination at 950 °C for 8 hours, so as to obtain lithium tantalum phosphate (LiTa₂PO₈) powder (hereinafter abbreviated as “LTPO powder”) of Preparation Example 1, which had a median particle size (d₅₀) ranging from 300 nm to 450 nm.

### <Preparation Example 2> Lithium Iron Phosphate Electrode Sheet

2 g of lithium iron phosphate (LiFePO₄, abbreviated as “LFP”; purchased from Advanced Lithium Electrochemistry Co., Ltd. (Aleees), Taiwan), 0.24 g of conductive carbon black (i.e., Super P® Li; average particle size: 30 nm; surface area: 62 m²/g; purchased from Imerys Graphite & Carbon Switzerland SA), 0.027 g of vapor-grown carbon fibers (abbreviated as “VGCF”; purchased from Yonyu Applied Technology Material Co., Ltd.), 0.107 g of lithium bis(trifluoromethanesulfonyl)imide (LiTFSI) (serving as a lithium salt), 0.08 g of the LTPO powder of Preparation Example 1, 3.05 g of a polyvinylidene fluoride (PVDF) solution (formed by dissolving PVDF in N-methyl-2-pyrrolidone (NMP), where the PVDF had a solid content of 7 wt % in the PVDF solution, had a weight-average molecular weight of 900,000, and was purchased from UBIQ Technology Co., Ltd. with Model: HSV 1800), and 3.5 g of N-methyl-2-pyrrolidone (NMP) were mixed in a mixer (Thinky Corporation; Model: ARE-310) for 2 hours, thereby obtaining a paste. Thereafter, a carbon-coated aluminum foil was used as a current collector, and the paste was coated onto the carbon-coated aluminum foil, thereby obtaining a coated laminate. Next, the coated laminate was first dried at 60 °C for 12 hours, and then at 120 °C for 6 hours, thereby obtaining a lithium iron phosphate electrode sheet of Preparation Example 2, which included the carbon-coated aluminum foil and an active layer that was disposed on a surface of the carbon-coated aluminum foil and which was formed from the paste.

### <Preparation Example 3> Lithium Salt Electrolyte

A commercially available lithium salt electrolyte, which contained a composite solvent containing ethylene carbonate and dimethyl carbonate in a volume ratio of 1:1, lithium difluoro(oxalato)borate having a molar concentration of 1 M, and lithium difluorophosphate having a weight percentage concentration of 1 wt %, was provided and served as a lithium salt electrolyte of Preparation Example 3.

### <Example 1> Solid-State Electrolyte Membrane

First, 2 g of poly(vinylidene fluoride-co-hexafluoropropylene) (hereinafter abbreviated as “PVDF-HFP”; weight-average molecular weight: 400,000; purchased from Sigma-Aldrich Corporation), 0.4 g of succinonitrile (abbreviated as “SN”; serving as a plasticizer), and 9 g of N, N-dimethylformamide (abbreviated as “DMF”; serving as a first solvent) were mixed to obtain a polymer solution. Subsequently, 2 g of lithium bis(trifluoromethanesulfonyl)imide (serving as a lithium salt; hereinafter abbreviated as “LiTFSI”; purchased from Sigma-Aldrich Corporation) was mixed with the polymer solution, followed by stirring at 65 °C for 4 hours, thereby obtaining a lithium salt-polymer composite solution. After that, 2 g of the LTPO powder of Preparation Example 1 was dispersed in 9 g of DMF (serving as a second solvent) to form an LTPO dispersion, and then the LTPO dispersion was mixed with the lithium salt-polymer composite solution, and then stirred at 65 °C for 6 hours, followed by degassing, so as to obtain a slurry.

Afterward, the slurry was coated onto a glass substrate to form a thin film. Subsequently, the thin film was dried in a vacuum oven at 60 °C under a pressure of −0.1 MPa for 48 hours, and then at 80 °C for 2 hours under the identical pressure to remove most of the residual DMF, followed by pressurizing at 1000 psi for 2 minutes to remove the remaining DMF, so as to obtain a membrane body serving as a solid-state electrolyte membrane of Example 1, which was stored in a glove box to prevent contamination from moisture and air.

### <Example 2> Solid-State Electrolyte Membrane

The procedures for preparing the solid-state electrolyte membrane of this example were similar to those of Example 1, except that, after the membrane body was obtained, 10 μL of the lithium salt electrolyte of Preparation Example 3 was dropped onto the membrane body to distribute the lithium salt electrolyte thereon, thereby obtaining the solid-state electrolyte membrane of Example 2.

### <Comparative Example> Lithium Tantalum Phosphate Pellet

10 g of the LTPO powder of Preparation Example 1 and zirconia balls at a weight ratio of 1:10 were subjected to ball milling in a 3D shaker mixer (Willy A. Bachofen AG; Model: TURBULA®) at a rotation speed of 100 rpm for 8 hours to obtain a processed LTPO powder. Next, the processed LTPO powder was sieved and then pressed at 30 MPa to form a 16 mm diameter circular pellet. Subsequently, the circular pellet was subjected to sintering at 1050 °C for 10 hours with a heating rate of 2 °C/min, thereby obtaining a lithium tantalum phosphate pellet (hereinafter abbreviated as “LTPO pellet”).

### <Application Example 1> Coin-Type Cell

The coin-type cell used in this application example was assembled from an electrolyte, a negative electrode, and a positive electrode, following the specifications of a CR2032 coin-type cell. The electrolyte was the solid-state electrolyte membrane (or the membrane body) of Example 1, which had a diameter of 18 mm and a thickness of 135-145 μm. The negative electrode was a lithium metal foil having a diameter of 16 mm and a thickness of 450 μm. The positive electrode was the lithium iron phosphate electrode sheet of Preparation Example 2, which had a diameter of 13 mm and a thickness of 35-45 μm.

### <Application Example 2> Coin-Type Cell

The procedures for preparing the coin-type cell of this application example were similar to those of Application Example 1, except that, after assembling the electrolyte, the negative electrode, and the positive electrode, 10 μL of the lithium salt electrolyte of Preparation Example 3 was injected between the electrolyte and the positive electrode, so as to obtain the coin-type cell of Application Example 2.

### <Application Example 3> Pouch-Type Cell

The pouch-type cell of this application example was prepared by assembling an electrolyte, a negative electrode, and a positive electrode according to the specifications of a pouch-type cell. After that, 10 μL of the lithium salt electrolyte of Preparation Example 3 was injected between the electrolyte and the positive electrode. The electrolyte was the solid-state electrolyte membrane (or the membrane body) of Example 1, which had an area of 3.7 cm×5.2 cm and a thickness of 135-145 μm. The negative electrode was a lithium metal foil having an area of 3.5 cm×5.0 cm, and a thickness of 100 μm. The positive electrode was the lithium iron phosphate electrode sheet of Preparation Example 2, measuring 3.3 cm×4.8 cm and 35-45 μm thick.

### <Application Example 4> Coin-Type Cell

The coin-type cell in this application example was prepared by assembling an electrolyte, a negative electrode, and a positive electrode according to the specifications for coin cell batteries. The electrolyte was the solid-state electrolyte membrane of Example 1, which had a diameter of 18 mm and a thickness of 135-145 μm. Both the negative and positive electrodes were lithium metal foils, each having a diameter of 16 mm and a thickness of 450 μm.

### <Application Example 5> Coin-Type Cell

The procedures for preparing the coin-type cell in this application example were similar to those in Application Example 4, except that, after assembling the electrolyte, the negative electrode, and the positive electrode, 10 μL of the lithium salt electrolyte of Preparation Example 3 was injected between the electrolyte and the positive electrode.

### <Measurement of Lithium-Ion Conductivity>

A gold film was formed on a surface of each of the solid-state electrolyte membranes of Examples 1 and 2, and the LTPO pellet of Comparative Example, by sputtering, thereby obtaining a test sample. Afterward, the test sample was secured with a fixture and placed in a constant-temperature chamber. Subsequently, the test sample was subjected to measurement of lithium-ion conductivity performed by electrochemical impedance spectroscopy (EIS; or AC Impedance) with a potentiostat (Bio-Logic Science Instruments SAS; Model: SP-300) at a fixed amplitude of 10 mV and a frequency ranging from 1 MHz to 100 mHz, while a temperature of the constant-temperature chamber was set at K °C (where K=25, 30, 40, 50, 60, 70 or 80), so as to determine the bulk resistance (R; unit: (2) of the test sample at such temperature. The lithium-ion conductivity of the test sample at each of the above-mentioned temperatures was calculated using the following Equation (1):

σ=L/RA (1)
where σ=lithium-ion conductivity of the test sample (S/cm)
L=thickness of the test sample (cm)
   R=bulk resistance of the test sample (Q)
A=cross-sectional area of the test sample (cm²)

The results are shown in Table 1 below.

TABLE 1

| | Solid-state | Solid-state | |
|---|---|---|---|
| | electrolyte | electrolyte | LTPO pellet of |
| | membrane of | membrane of | Comparative |
| | Example 1 | Example 2 | Example |
| | σ (S/cm) | σ (S/cm) | σ (S/cm) |
| 25 °C | 0.59 × 10⁻³ | 1.17 × 10⁻³ | 0.17 × 10⁻³ |
| 30 °C | 0.84 × 10⁻³ | 2.25 × 10⁻³ | 0.21 × 10⁻³ |
| 40 °C | 1.03 × 10⁻³ | 4.03 × 10⁻³ | 0.30 × 10⁻³ |
| 50 °C | 1.27 × 10⁻³ | 4.33 × 10⁻³ | 0.40 × 10⁻³ |
| 60 °C | 1.56 × 10⁻³ | 4.58 × 10⁻³ | 0.55 × 10⁻³ |
| 70 °C | 1.91 × 10⁻³ | 4.76 × 10⁻³ | 0.63 × 10⁻³ |
| 80 °C | 2.35 × 10⁻³ | 5.13 × 10⁻³ | 0.82 × 10⁻³ |

Referring to Table 1, at each temperature, the lithium-ion conductivities of the solid-state electrolyte membranes of Examples 1 and 2 were both higher than that of the LTPO pellet of Comparative Example.

### <Charge-Discharge Cycling Test for Coin-Type Cells>

Each of the coin-type cells of Application Examples 1 and 2 was subjected to a charge-discharge cycling test using a battery testing system (Acutech Systems Co., Ltd.; Model: BAT-750B) under the conditions shown in Table 2 below. The average Coulombic efficiency and the discharge capacity retention rate thereof were calculated using the following Equations (2) and (3), respectively:

$${CE}_{avg} = \frac{1}{N} {\sum }_{a = 1}^{N} ( \frac{\begin{matrix}discharge specific capacity \\ at the {a}^{th} cycle\end{matrix}}{\begin{matrix}charge specific capacity \\ at the {a}^{th} cycle\end{matrix}} \times 100 \% ) \qquad ( 2 )$$

where CE_{avg}=average Coulombic efficiency (%)
   N=total number of cycles
a=cycle number (from 1 to N)

R=(Cₛₐ/Cₛᵢ)×100% (3)
where R=discharge capacity retention rate (%)
   Cₛₐ=discharge specific capacity of the a^{th} cycle (mAh/g)
Cₛᵢ=initial discharge specific capacity (mAh/g)

The results are shown in Table 2 below.

TABLE 2

| | Coin-type cell | | | | |
|---|---|---|---|---|---|
| | Application | | | | |
| | Example 1 | Application Example 2 | | | |
| Temperature | 25 | 25 | 25 | 45 | 25 |
| (°C) | | | | | |
| Charge rate (C) | 0.2 | 0.2 | 1 | 2 | 0.5 |
| Discharge rate | 0.2 | 0.2 | 1 | 2 | 2 |
| (C) | | | | | |
| Voltage (V) | 2.5 to 4.0 | | | | |
| Total number of | 100 | 100 | 800 | 300 | 1740 |
| cycles | | | | | |
| Initial discharge | 143.39 | 150.93 | 129.2 | 151.1 | 129.6 |
| specific | | | | | |
| capacity | | | | | |
| (mAh/g) | | | | | |
| Discharge | 115.0 | 145.5 | 127.4 | 146.1 | 119.5 |
| specific | (a = 100) | (a = 100) | (a = 800) | (a = 300) | (a = 1740) |
| capacity at the | | | | | |
| a^{th} cycle | | | | | |
| (mAh/g) | | | | | |
| Average | 98.6 | 99.9 | 99.9 | 99.8 | 97.9 |
| Coulombic | | | | | |
| efficiency (%) | | | | | |
| Discharge | 80.2 | 96.4 | 92.3 | 96.7 | 92.2 |
| capacity | | | | | |
| retention rate | | | | | |
| (%) | | | | | |

### <Charge-Discharge Cycling Test for Pouch-Type Cell>

The pouch-type cell of Application Example 3 was subjected to charge-discharge cycling testing using the aforesaid battery testing system under the conditions shown in Table 3 below. The average Coulombic efficiency and the discharge capacity retention rate thereof were calculated using the following Equations (4) and (5), respectively:

$${CE}_{avg} = \frac{1}{30} {\sum }_{a = 1}^{30} ( \frac{\begin{matrix}Total discharge capacity \\ of the {a}^{th} cycle\end{matrix}}{\begin{matrix}Total charge capacity \\ of the {a}^{th} cycle\end{matrix}} \times 100 \% ) \qquad ( 4 )$$

where CE_{avg}=average Coulombic efficiency (%)
a=cycle number (from 1 to 30)

R=(C₃₀/Cᵢ)×100% (5)
where R=discharge capacity retention rate (%)
   C₃₀=total discharge capacity of the 30^{th} cycle (mAh)
Cᵢ=initial total discharge capacity (mAh)

TABLE 3

| | Pouch-type cell |
|---|---|
| | Application Example 3 |
| Temperature (°C) | 25 |
| Charge rate (C) | 0.1 |
| Discharge rate (C) | 0.1 |
| Voltage (V) | 2.5 to 4.0 |
| Total number of cycles | 30 |
| Initial discharge specific | 7.95 |
| capacity (mAh/g) | |
| Discharge specific | 7.28 |
| capacity at the 30^{th} cycle | |
| (mAh/g) | |
| Average Coulombic | 99.2 |
| efficiency (%) | |
| Discharge capacity | 91.6 |
| retention rate (%) | |

Referring to Tables 2 and 3, each of the coin cell batteries of Application Examples 1 and 2 and the pouch-type cell of Application Example 3 exhibited a high average Coulombic efficiency and a high discharge capacity retention rate.

### <Battery Short-Circuit Test>

Each of the coin cell batteries of Application Examples 4 and 5 was subjected to a charge-discharge cycling test using a battery testing system (Shenzhen Neware Electronics Co., Ltd.; Model: ABT-408T-5V50 mA-164-U) for a total time period of 1500 hours under the following conditions: for charge conditions, a temperature of 25 °C, an areal capacity maintained at 1 mAh/cm², and a current density of 0.2 mA/cm²; and for discharge conditions, a temperature of 25 °C, an areal capacity maintained at 1 mAh/cm², and a current density of 0.2 mA/cm². After the charge-discharge cycling test, a recording of “No” was assigned if a short circuit did not occur in the coin-type cell, and a recording of “Yes” was assigned if a short circuit occurred in the coin-type cell.

The results are shown in Table 4 below.

TABLE 4

Coin-type cell

| | Application | Application |
|---|---|---|
| | Example 4 | Example 5 |
| Occurrence | No | No |
| of a short- | | |
| circuit | | |

Referring to Table 4, no short-circuit occurred in the coin cell batteries of Application Examples 4 and 5 after the charge-discharge cycling test, indicating that both the coin cell batteries of Application Examples 4 and 5 possessed excellent battery stability.

In summary, the solid-state electrolyte membrane of the present disclosure, which is formed from lithium tantalum phosphate, poly(vinylidene fluoride-co-hexafluoropropylene), the lithium salt, and the plasticizer, exhibits high lithium-ion conductivity. In addition, when the solid-state electrolyte membrane further includes the lithium salt electrolyte, it shows even higher lithium-ion conductivity. The solid-state lithium battery of the present disclosure, by virtue of inclusion of the aforementioned solid-state electrolyte membrane, possesses a high average Coulombic efficiency, a high discharge capacity retention rate, and excellent battery stability. Moreover, when the solid-state lithium battery of the present disclosure further includes the lithium salt electrolyte, it shows an even higher average Coulombic efficiency and a higher discharge capacity retention rate. Accordingly, the objectives of the present disclosure can indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A solid-state electrolyte membrane, comprising:
a membrane body including lithium tantalum phosphate, poly(vinylidene fluoride-co-hexafluoropropylene), a lithium salt, and a plasticizer; and
a lithium salt electrolyte which is distributed on the membrane body, and which contains lithium difluoro(oxalato)borate, lithium difluorophosphate, and a composite solvent which contains ethylene carbonate and dimethyl carbonate,
wherein in the lithium salt electrolyte, a molar concentration of the lithium difluoro(oxalato)borate is 1 M, a weight percentage concentration of the lithium difluorophosphate is 1 wt %, and a volume ratio of the ethylene carbonate to the dimethyl carbonate is 1:1.

2. The solid-state electrolyte membrane as claimed in claim 1, wherein the lithium salt is selected from the group consisting of lithium bis(trifluoromethanesulfonyl)imide, lithium perchlorate, lithium trifluoromethanesulfonate, lithium bis(oxalato)borate, lithium tetrafluoroborate, and combinations thereof.

3. The solid-state electrolyte membrane as claimed in claim 1, wherein the plasticizer is selected from the group consisting of succinonitrile, adiponitrile, lithium azide, polyethylene glycol, poly(ethylene glycol) diacrylate, triallyl isocyanurate, and combinations thereof.

4. The solid-state electrolyte membrane as claimed in claim 1, wherein the lithium tantalum phosphate is present in an amount ranging from 10 parts by weight to 150 parts by weight based on a total amount of the poly(vinylidene fluoride-co-hexafluoropropylene) as 100 parts by weight.

5. The solid-state electrolyte membrane as claimed in claim 1, wherein a weight ratio of the poly(vinylidene fluoride-co-hexafluoropropylene) to the lithium salt ranges from 1:1 to 3:1.

6. The solid-state electrolyte membrane as claimed in claim 1, wherein the plasticizer is present in an amount of 20 parts by weight based on a total amount of the poly(vinylidene fluoride-co-hexafluoropropylene) as 100 parts by weight.

7. A solid-state lithium battery, comprising:
a positive electrode;
a negative electrode spaced apart from the positive electrode; and
an electrolyte including a solid-state electrolyte membrane as claimed in claim 1, the solid-state electrolyte membrane being disposed between the positive electrode and the negative electrode, a portion of the lithium salt electrolyte being distributed between the positive electrode and the solid-state electrolyte membrane.

8. The solid-state lithium battery as claimed in claim 7, wherein the lithium salt electrolyte is present in an amount of 0.4 parts by weight based on a total amount of the positive electrode, the negative electrode and the solid-state electrolyte membrane as 100 parts by weight.

9. The solid-state lithium battery as claimed in claim 7, wherein the positive electrode includes a current collector and an active layer disposed on a surface of the current collector, the active layer including lithium iron phosphate and lithium tantalum phosphate.
